(19) United States
(12) Patent Application Publication
(10) Pub. No.: US 2005/0255992 A1
(43) Pub. Date: Nov. 17, 2005

(54) Rhodium-rich catalysts doped with rare earth oxides

(76) Inventors: Wolfgang Strehlau, Dossenheim (DE); Wolfram Stichert, Heidelberg (DE); Jurgen Bechtel, Heidelberg (DE); Jurgen Maier, Mannheim (DE)

Correspondence Address: Stephen D Scanlon;Jones Day, North Point, 901 Lakeside Avenue, Cleveland, OH, 44114, US

(21) Appl. No.: 10/506,082

(22) PCT Filed: Mar. 3, 2003
(86) PCT No.: PCT/EP03/02166

§ 371 Date: Apr. 14, 2005

(30) Foreign Application Priority Data
Mar. 4, 2002 (DE) 102-09-529.9

(51) Int. Cl. B01D 53/92

(52) U.S. Cl. 502/302; 423/213.5

(57) ABSTRACT

The present invention relates to a novel catalyst comprising at least one support material, rhodium as active metal either alone or in combination with further active metals from the platinum metal group and also at least one rare earth oxide as promoter, where the mass ratio of rhodium to the sum of further active metals from the platinum metal group is at least 1:4.5. In contrast to the catalysts of the prior art, aging or deactivation caused by sulphur-containing deposits can be minimised in the catalyst of the invention. The present invention further provides a method of purifying exhaust gas from internal combustion engines which are predominantly operated in a lean mode and in which the catalysts of the invention are used in a rich-lean cycle.

The present invention relates to a novel catalyst comprising at least one support material, rhodium as active metal either alone or in combination with further active metals from the platinum metal group and also at least one rare earth oxide as promoter, wherein the mass ratio of rhodium to the sum of further active metals from the platinum metal group is at least 1:4.5. In contrast to the catalysts of the prior art, ageing or deactivation caused by sulphur-containing deposits can be minimised in the catalyst of the invention. The present invention further provides a method of purifying exhaust gas from internal combustion engines which are predominantly operated in a lean mode and in which the catalysts of the invention are used in a rich-lean cycle.

The important objectives which have to be achieved in internal combustion engines include, at least since the 1970s, reduction of the fuel consumption and minimisation of pollutant emissions. Owing to the predominant importance of these parameters, in particular due to the continually increasing density of traffic and limited resources (among which a pollutant-free atmosphere now has to be included), very intensive work has been carried out in this field. This fact is reflected, in particular, in a comprehensive prior art.

Despite the large number of existing approaches to a solution, there are still many problems which are of particular significance in the technical field, in particular the problem of improving the ageing resistance of catalysts and their resistance to deactivation by sulphur compounds which is addressed in the present invention. This applies particularly to catalysts which are used for purifying exhaust gases from engines operated in the so-called non-stoichiometric region. Such a mode of operation occurs, for example, in engines which are run preferentially under lean conditions, i.e. at an excess of oxygen, and which are regarded as a type of engine which is of particular significance for the future.

An overview of NOₓ catalysis in general with references to the most common exhaust gas catalysts and in particular DeNOₓ catalysts and NOₓ storage catalysts may be found in W. Strehlau et al. Neue Entwicklungen in der katalytischen Abgasnachbehandlung von Magermotoren, “Motor und Umwelt” conference (1997) and in Weisweiler Entfernen von Stickstoffoxiden aus Sauerstoff enthaltenden Automobilabgasen, Chemie. Ing. Technik 72 (2000) pp. 441-449. This document focuses on the description of catalysts for engines into which gasoline is injected directly (fuel-injection engines), i.e. for lean-burn engines. In particular, it is stated that catalysts using continuous DeNOₓ technologies of the prior art are not sufficiently selective in lean operation to allow exhaust gases to be freed of nitrogen oxides, hydrocarbons and carbon monoxide, so that they adhere to the limits for the loading of exhaust gases with the above-mentioned substances which apply in Europe at present and in the future (EURO III/IV). Disadvantages of DeNOₓ catalysts are that Pt catalysts in this mode of operation display increased nitrous oxide formation and zeolite catalysts have an unsatisfactory thermal stability. The unsatisfactory efficiency of DeNOₓ catalysts for lean-burn engines can be attributed quite generally to the oxygen excess prevailing in lean operation, which hinders the catalytic reduction of NOₓ over active metals. The DeNOₓ catalysts under discussion are, for example, HC-SCR catalysts (SCR=selective catalytic reduction; HC=hydrocarbon) using iridium and platinum technologies, as are described, inter alia, in US 5 474 965 or EP A 0 602 602.

A technology which is superior to the HC-SCR catalysts makes use of the storage (adsorption) of NOₓ in basic oxides during lean operation. Nitrates formed in this way are then decomposed catalytically into nitrogen and oxygen in a complicated, programmed sequence of running the engine in short “slightly rich phases” (i.e. with a deficiency of oxygen) under then reducing conditions. Such catalysts are accordingly described as “NOₓ storage catalysts” or as “NOₓ adsorbers”. The function of such storage catalysts is described in detail in the SAE document 950809. Suitable NOₓ storage materials are in principle all materials which, owing to their basic properties, are able to store nitrogen oxides as nitrates, which have to be stable under the prescribed temperature conditions. Preference is accordingly given to salts of the alkali metals (Na, K, Rb, Cs) and the alkaline earth metals (Mg, Ca, Sr, Ba) as storage materials, with the salts preferably being oxides, hydroxides or carbonates.

For the purposes of the present invention, the generic terms “alkali metal oxides”, “alkaline earth metal oxides” and “rare earth oxides” generally encompass not only the stoichiometric oxides but also the corresponding carbonates, hydroxides, suboxides, mixed oxides and any mixtures of at least two of the abovementioned substances. The term “NOₓ storage materials” refers to appropriate alkali metal oxides and/or alkaline earth metal oxides according to the definition just given. However, a noticeable disadvantage for the commercial use of these catalysts is the strong tendency of the basic NOₓ storage materials to form sulphates. Deactivation and/or poisoning of catalysts becomes apparent, in particular, in long-term use, i.e. for example up to 160,000 km in the case of automobile engines. The first effects of ageing and deactivation can appear, depending on the mode of operation, after only 5-20 hours of operation. Even in low-sulphur fuels, the sulphur content is high enough for, especially in long-term operation, sufficient sulphates to be deposited on the catalyst as a result of the high affinity of the basic alkali metal oxides or alkaline earth metal oxides for SO₂ and SO₃ (=SOₓ) to deactivate the catalyst to a substantial extent. In principle, desulphation (=removing of S) can be carried out by making the exhaust gas slightly rich and increasing the temperature. However, in the case of alkali metal oxides and alkaline earth metal oxides as NOₓ storage materials, this is only possible above temperatures of >600° C. in the simultaneous presence of air index numbers of <1. Such exhaust gas conditions are difficult to achieve in gasoline engines in lean operation, particularly when they are not run under high load from time to time. In the case of diesel engines, such exhaust gas conditions do not occur at all in realistic practical operation.

Specific instructions for producing such an NOₓ storage catalyst may be found, for example, in U.S. Pat. No. 6,004,521. The catalyst described there for the purification of exhaust gases under non-stoichiometric conditions comprises (i) a heat-resistant substrate, (ii) a porous layer applied to the substrate, (iii) platinum or palladium as active component and (iv) an NOₓ store in a well-defined molar ratio to the substrate. The NOₓ store is selected from among the salts of: Ba, Sr, Ca (preferred), La and Y and also Li, Na and K. Further significant characteristics of the catalyst of U.S. Pat. No. 6,004,521 are the direct proximity of the storage material to the active metal and the fine dispersion of the two components in the porous layer. Since the catalysts mentioned in this document are NOₓ storage catalysts, the abovementioned problems in respect of deactivation resulting from sulphur deposits are particularly relevant. The problem of ageing of NOₓ storage catalysts is addressed in EP A 0 982 066, although the possible reaction of the storage material with the support rather than ageing/deactivation as a result of sulphur deposits is discussed there. As a solution to this problem, it is proposed that doped cerium oxide, cerium/zirconium mixtures, titanates, stannates, zirconates, rare earth metal oxides or mixtures thereof be used as support materials.

Rare earth oxides in NOₓ storage catalysts in conventional λ-controlled three-way operation are used in various ways, either (i) as described in EP 0 982 066 as support for the actual active basic storage materials, (ii) as oxygen store for supporting the function of the catalyst under approximately stoichiometric exhaust gas conditions, (iii) for the thermal stabilisation of oxidic supports or (iv) as NOₓ storage material itself. Especially with regard to point (iv), lanthanum oxide is particularly preferred because of its high basicity compared to all other rare earth oxides.

Thus, for example, EP 0 645 173 describes an NOₓ storage catalyst in which lanthanum oxide is used together with an alkali metal oxide or alkaline earth metal oxide. The addition of alkali metal oxides or alkaline earth metal oxides is necessary since the NOₓ storage efficiency of the lanthanum oxide alone is not sufficient. The patent discloses a mixture of platinum and palladium as active metals. Rhodium is not used at all in this patent. The catalysts mentioned in the examples of EP 0 692 302 provide only for the use of lanthanum oxide together with at least one further alkali metal oxide or alkaline earth metal oxide, as in EP 0 645 173. The inventors propose a platinum/rhodium mass ratio of 5:1, preferably 10:1 or above.

An alternative approach to NOₓ storage catalysts has been put forward in T. Nakatsuji et al., Appl. Catalysis B 21 (1999) 121-132, or in T. Nakatsuji and V. Komppa, Appl. Catalysis B 30 (2001) 209-223. The catalysts described in these studies consist essentially of rhodium, iridium or platinum on a porous support and are subject to a “two-phase NOₓ reduction cycle” i.e. a phase of lean operation followed by a precisely defined but at least ten times shorter phase of rich operation. It was found that the Rh catalyst in particular operates by a completely different mechanism under the rich-lean conditions specified than do the NOₓ storage catalysts discussed above. The novel mechanism probably comprises (i) dissociation of the nitrogen oxides into nitrogen and oxygen during the lean phase over reduced Rh followed by (ii) further reduction of the resulting oxidised Rh in a short rich phase.

Since no strongly basic oxides such as, in particular, alkali metal oxides or alkaline earth metal oxides are used in this process, the problem of deactivation of the active metal by formation of no longer decomposable sulphates which occurs in the case of NOₓ storage catalysts is circumvented. However, a disadvantage of the Nakatsuji catalyst is the exclusive reliance on Rh as catalytically active component. It is therefore of importance for practical use to provide a catalyst which has an improved efficiency compared with the Nakatsuji catalysts, in particular a catalyst which does not rely on the sole presence of rhodium and/or other platinum metals for the reduction of the oxygen formed on decomposition of nitrogen oxides in the lean phase.

The abovementioned catalysts of the prior art which are used for the treatment of exhaust gases from combustion engines, i.e. in particular for the simultaneous reduction of nitrogen oxides to nitrogen, oxidation of hydrocarbons to water and carbon dioxide and the oxidation of carbon monoxide to carbon dioxide, are characterized by at least one of the following disadvantages: (i) they cannot be used for engines in lean operation, in particular not for engines which operate continuously, i.e. virtually exclusively, under lean conditions, (ii) they display deactivation in long-term operation due to formation of sulphatic deposits which cannot readily be decomposed in normal operation and (iii) the efficiency for exhaust gas purification at a high throughput is too low for commercial applications as a result of the sole use of an active metal.

It is therefore an object of the invention to provide a novel three-way catalyst which can be used in a method of purifying exhaust gases from internal combustion engines which are operated for at least some of the time under lean conditions. It should be ensured that, in particular, the poisoning/loading with sulphates which occurs in the case of NOₓ storage catalysts of the prior art during the course of ageing and cannot be reversed readily in realistic operation is minimised and that the efficiency of the NOₓ decomposition catalysts described in the prior art which are based on rhodium as active metal and are operated in a rich-lean cycle is significantly increased.

The object of the invention is achieved by the provision of a novel catalyst which is characterized in that it comprises rhodium as active metal, either alone or in a mass ratio of at least 1:4.5 relative to the sum of further active metals, preferably from the platinum group, and also at least one rare earth oxide as promoter for the active metal. In the method of the invention, this novel catalyst is operated in a rich-lean cycle.

Significant terms which are of importance for the understanding and interpretation of the present invention will be defined below.

Combustion engines are thermal energy converters which transform chemical energy stored in fuels into heat by means of combustion and finally into mechanical energy. In the case of internal combustion engines, the air enclosed in a gastight and alterable working space (e.g. a cylinder) is the working medium defined in the sense of a heat engine and is at the same time the carrier of the oxygen required for combustion. Combustion occurs cyclically, with both the fuel and the (atmospheric) oxygen being freshly charged before each cycle. Depending on the specific cycle, e.g. described by means of a Carnot pV-work diagram, a precise thermodynamic distinction can be made between a gasoline (or 4-stroke spark ignition) engine and a diesel engine. A practical working definition of these types of engine is given below.

An important criterion for classifying both engine types and catalyst types is the ratio of gasoline to air, expressed by means of the “air index” λ. A value of λ=1.0 corresponds precisely to the stoichiometric ratio of gasoline to dry air, i.e. there is just enough air in the combustion chamber for all the gasoline to be able to burn stoichiometrically to carbon dioxide and water. In the technical literature, mixtures having a λ of >1 are referred to as “lean” (oxygen excess) and those having a λ of <1 are referred to “rich” (oxygen deficiency). For the purposes of the present invention, mixtures having a λ of >1.2 will be referred to as “lean” and those having a λ of <1.0 will be referred to as “rich” in order to provide a clear delineation from the stoichiometric region. Accordingly, the rich and/or lean mixtures defined in this way are also referred to as nonstoichiometric mixtures for the purpose of the invention.

Conventional gasoline engines are characterized by the formation of a homogeneous gasoline/air mixture outside the working space, i.e. the cylinder space, in which combustion takes place and by controlled externally induced ignition. Gasoline engines require low-boiling and readily ignitable fuels (the ignition limits of a gasoline engine are typically in the range from λ=0.6 to λ=1.4). In the context of the present invention, it is of particular importance in terms of exhaust gas catalysis that conventional gasoline engines which have a three-way catalyst regulated via a λ probe are operated predominantly at a λ value of about 1 (=stoichiometric operation).

“Lean-burn engines” are gasoline engines which are operated predominantly with an excess of oxygen. For the purposes of the present invention, lean-burn engines are defined specifically by means of their λ value, i.e. lean-burn engines for the purposes of the present invention are engines which are, apart from fuel cut-off shutdowns, operated at least part of the time in the lean state, i.e. at a λ value of 1.2 or above. In addition, it is naturally also possible for rich operating states to occur during the running of lean-burn engines: brief rich running of the engine and thus rich exhaust gases can be initiated by the engine electronics in modern injection systems or can also occur in natural operation while driving (e.g. in the case of load increases, at full load or when starting). An alternating operating mode made up of rich and lean cycles will be referred to as “rich-lean operation” for the purposes of the present invention.

In particular, lean-burn engines are, for the purposes of the invention, generally the following embodiments:
All gasoline engines with direct injection (fuel-injection engines) and operating at λ>1, and also all gasoline engines having external formation of the mixtures. This class includes, inter alia, stratified charge engines, i.e. engines which have an ignitable mixture in the vicinity of the spark plug but otherwise an overall lean mixture, and also gasoline engines having unthrottled or slightly throttled part-load operation and/or high compression in combination with direction injection. Examples of such engines are engines operated according to the Mitsubishi method (GDI=gasoline direct injection; common rail injection), the FSI (=fuel stratified injection) engine developed by VW or the IDE (=injection directe essence) engine designed by Renault;
all diesel engines (see below);
multifuel engines, i.e. engines which burn readily ignitable and/or difficult-to-ignite fuels, fuel mixtures such as alcohols, bioalcohols, vegetable oils, kerosene, gasoline and any mixtures of two or more of the abovementioned substances.

Diesel engines are characterized by mixture formation of an ignitable mixture, a heterogeneous fuel/air mixture and by self ignition. Accordingly, diesel engines demand ignitable fuels. In the context of the present invention, it is of particular importance that diesel exhaust gases have similar characteristics to the exhaust gases from lean-burn engines, i.e. continuously lean, namely oxygen-rich. Consequently, the catalysts for NOₓ reduction in conjunction with diesel engines have to meet similar demands in terms of nitrogen oxide elimination as do catalysts which are used for gasoline engines operated under lean conditions. However, a significant difference between diesel passenger car engines and gasoline passenger car engines is the generally lower exhaust gas temperatures of diesel passenger car engines (from 100° C. to 350° C.) compared with gasoline passenger car engines (from 250° C. to 650° C.) which occur during legally prescribed running cycles. A relatively low exhaust gas temperature makes the use of catalysts which are not or only slightly prone to sulphate contamination particularly attractive, since desulphating is, as stated above, effective only at exhaust gas temperatures above about 600° C. All that which has been said in the context of the present invention with regard to catalysts for lean-burn engines therefore also applies analogously to catalysts which are used for diesel engines.

Catalysts specifically matched to different engines are required for exhaust gas treatment as a function of the mixture formation and the characteristic load-engine revolutions curve. Thus, for example, a catalyst for a conventional gasoline engine whose gasoline/air mixture is continuously set to λ≈1 by means of injection and a throttle and whose air index is optionally monitored by means of a λ probe requires completely different functionalities for the reduction of NOₓ than does, for example, a catalyst for a lean-burn engine which is operated at λ>1.2, i.e. has an oxygen excess in normal operation. It is obvious that a catalytic reduction of NOₓ over an active metal is made difficult in the presence of an excess of oxygen.

The term “three-way catalyst” as used for the purposes of the present invention refers quite generally to catalysts which remove three significant pollutants in the exhaust gas from combustion engines, namely nitrogen oxides (NOₓ) by reduction to nitrogen, carbon monoxide by oxidation to carbon dioxide and hydrocarbons by oxidation to, in the ideal case, water and carbon dioxide. When a catalyst is used in diesel engines, a fourth task, namely the removal of soot by oxidation, can be added to the three tasks already mentioned.

Conventional three-way catalysts for gasoline engines according to the prior art are used in stoichiometric operation i.e. at λ values which are in a narrow range around 1.0. The λ value is set by regulating the gasoline/air mixture in the combustion chamber with the aid of injection devices and a throttle. In non stoichiometric operation, i.e. in non conventional operation, it is possible for λ values which deviate significantly from 1.0, for example λ>1,2 or λ>2.0 or else λ<0.9, to occur. The discontinuous operation of an engine, i.e. alternating operation between lean and rich modes of operation of the engine is referred to as rich-lean operation.

A particular embodiment of a three-way catalyst which can also be operated under non-stoichiometric conditions, in particular when lean states occur, is the NOₓ storage catalyst. For the purposes of the present invention, an NOₓ storage catalyst is a three-way catalyst which can function in rich-lean operation and whose chemical composition allows the nitrogen oxides NOₓ to be stored in a storage medium, typically a basic alkali metal oxide or alkaline earth metal oxide, in lean operation and the actual decomposition of the stored nitrogen oxides into nitrogen and oxygen to occur only in a rich phase under reducing exhaust gas conditions.

In contrast, an NOₓ decomposition catalyst is, for the purposes of the present invention, a three-way catalyst which can likewise function in rich-lean operation and whose chemical composition allows the nitrogen oxides NOₓ to be decomposed into nitrogen and oxygen over the catalyst in lean operation. In addition, the decomposition catalyst is active in respect of the oxidation of carbon monoxide and hydrocarbons to carbon dioxide and water.

As criterion for distinguishing an NOₓ storage catalyst from the catalyst according to the invention which can formally be designated as an NOₓ decomposition catalyst, the Rh content of the active metal can be employed for the purposes of the present invention. It is known that Rh, in contrast to Pt, as active metal forms only little NO₂ which can be stored in basic oxides from the nitrogen oxides. Accordingly, replacement of Pt by Rh (i.e. an increase in the Rh content) in NOₓ storage catalysts leads to a reduced catalytic activity in lean operation and thus to less efficient NOₓ removal. This means that little if any Rh is used for NOₓ storage catalysts and that the use of significant or even predominant proportions of Rh have been regarded by those skilled in the art as harmful to the solution to the problem of improving NOₓ conversion. Rh is used as additive even in conventional three-way catalysts. However, this is done to exploit the ability of Rh, like all metals of the platinum group, to react NOₓ, CO and hydrocarbons directly during stoichiometric and/or rich phases of operation.

On the other hand, Rh is, unlike the other platinum metals, particularly suitable for decomposing NOₓ directly into nitrogen and oxygen in lean operation. This means that in the absence of basic alkali metal oxides or alkaline earth metal oxides as storage media for NOₓ, replacement of Pt by Rh (i.e. an increase in the Rh content) leads to an increased catalytic activity and thus to more efficient NOₓ removal (with the proviso that reduction of the Rh is induced at least briefly during operation, i.e. by making the mixture richer). Accordingly, preference is given to using Rh in NOₓ decomposition catalysts. The particular mode of action of Rh compared with Pt becomes particularly apparent in the light of the surprising discovery that a significant increase in the activity in respect of nitrogen oxide conversion of the decomposition catalysts based on Rh (cf. Nakatsuji catalysts as described in the prior art) can be achieved by adding rare earth oxides as promoters to the active metal or metals.

Evidence for the surprising discovery that Rh in the catalyst of the invention reacts nitrogen oxides in lean operation by a different mechanism than do the Pt-based storage catalysts is provided by the following data: as is shown in the examples, it is found that the Rh-rich decomposition catalysts of the invention convert twice the amount of nitrogen oxides, i.e. are twice as effective, at temperatures above 360° C. than do the otherwise identical Pt-rich catalysts.

The method described in the present invention and the catalyst of the invention are designed for practicable long-term use for exhaust gas purification in motor vehicles. Accordingly, for the purposes of the present invention, “normal operation” refers to all exhaust gas compositions and temperatures which are typical for the operating points of an engine during the NEDC (new European driving cycle). In particular, starting of the engine, warming up and operation under extreme loads are not regarded as normal operation.

The catalyst of the invention comprises at least the following constituents:
(i) at least one porous support material;
(ii) rhodium as active metal, either alone or together with at least one further active metal, where the mass ratio, based on the elements, of rhodium to the sum of all further active metals in the catalyst is at least 1:4.5;
(iii) as dopant added to the active metal, at least one rare earth oxide which functions as promoter.

As porous support material, it is in principle possible to use any material which is porous and which withstands the maximum temperatures occurring during operation of the catalyst over the normal operating time for the removal of pollutants from motor vehicle exhaust gases. The refractory oxides, i.e. oxides which cannot be decomposed, and corresponding mixed oxides and/or oxide mixtures are of particular importance. For the purposes of the invention, preference is given to using those porous support materials which have been found to be useful for conventional three-way catalysts and/or storage catalysts. Particular preference is given to silicates, in particular aluminosilicates, especially zeolites, and also titanium oxides, aluminium oxides, silicon oxides, zirconium oxides or mixtures of at least two of the abovementioned substances.

As active metal, it is in principle possible to use any metal which, in the reduced state, can catalyse the decomposition of nitrogen oxides into nitrogen and oxygen, i.e. the transition metals and in particular the metals Cr, Mo, W, Mn, Fe, Co, Ni, Cu, Ag, Au, V, Nb or Ta. The metals of the platinum group, i.e. Ru, Rh, Pd, Re, Os and Ir, are more preferred. For the purposes of the present invention, the sole use of rhodium or the use of rhodium together with at least one further active metal from the platinum group is particularly preferred.

As regards the mass ratio of Rh to the sum of all further active metals, based on the elements, in the catalyst of the present invention, any value which leads to the catalyst of the invention displaying a better activity in rich-lean operation than do the catalysts of the prior art is conceivable in principle. A higher Rh content results in a greater catalytic activity. On the other hand, it has to be taken into account that Rh is at present about three times as expensive as platinum, so that for practical applications there is an economically optimal ratio of Rh to Pt which does not take account of only the activity of Rh. For the purposes of the present invention, a molar ratio of Rh to the sum of all further active metals of at least 1:1 is preferred. A ratio of at least 1:2 is more preferred and a ratio of at least 1:4 is even more preferred, with a ratio of at least 1:4.5 being particularly preferred.

The ratio to be chosen in a specific case also depends on the temperature range (temperature of the exhaust gases) in which the catalyst displays the highest activity in respect of the reduction of NOₓ. In particular, the low-temperature activity of the catalyst can be increased by addition of Pt to the Rh, but this is usually done at the expense of the high-temperature activity. Thus, the catalyst can be matched to the specific exhaust gas conditions of the particular engine by variation of the Rh:Pt ratio. For example, a catalyst according to the invention which is relatively rich in Pt would be advantageous for the after-treatment of diesel passenger car exhaust gases (relatively low exhaust gas temperatures), while a catalyst having a lower Pt content is advantageous for use in gasoline engines with fuel injection. As shown in the examples, it has also been found that doping of Rh with small amounts of Pt can lead to an increase in activity over the entire temperature range.

As regards the weight ratio of active metal, i.e. the sum of Rh and all further active metals used, to the support material, preference is given to a proportion of from 0.01% by weight to 5% by weight of active metal based on the total weight of active metal and support material, with a proportion by weight of from 0.1% by weight to 3% by weight being particularly preferred. As regards the proportion of rhodium relative to the porous support material on which it is immobilised, preference is given to a value of from 0.01% by weight to 5% by weight, with a value in the range from 0.1% by weight to 0.75% by weight being particularly preferred.

For the purposes of the present invention, the above-described active metal has to be doped with at least one rare earth oxide, since it has surprisingly been found according to the present invention that the addition of at least one rare earth oxide makes it possible to increase the activity of the Rh-rich catalyst which does not contain basic oxides, in particular no alkali metal oxides or alkaline earth metal oxides. The composition of the catalyst of the invention very probably results in it acting not as storage catalyst but as decomposition catalyst towards the nitrogen oxides. Thus, the sulphate formation typical of storage catalysts is prevented or at least minimised in the catalyst of the invention.

The rare earth oxide or oxides is/are selected from the group consisting of La, Ce, Pr, Nd, Sm, Eu, Gd, Tb, Dy, Ho, Er, Tm, Yb, Lu oxides and mixtures of at least two of these oxides. Since basic oxides promote the undesirable sulphate formation, particular preference is given according to the present invention to those rare earth oxides which have a low basicity. The basicity is determined simply by the atomic number of the rare earth metal, i.e. the further to the right that the rare earth element is located in the Periodic Table of the Elements, the less basic it is.

In this context, reference may be made to the results presented in A. F. Holleman and E. Wiberg, Lehrbuch derAnorganischen Chemie, Verlag Walter de Gruyter, 91^{st}-100^{th} Edition (1985), p. 1058, in particular to the fact that the basicity of the lanthanum oxides corresponds approximately to the basicity of calcium oxides, while the basicity of higher rare earth oxides, for example lutetium oxides corresponds to the basicity of Al₂O₃. These facts support the claim of the present invention that the addition of a rare earth oxide to Rh leads to a particularly effective NOₓ decomposition catalyst. While the effectiveness of storage catalysts is increased as they become more basic (Al₂O₃, for example, which is used as support material for many catalysts, displays only a low storage activity because of its low basicity while the more strongly basic calcium and in particular barium oxides are the most effective storage materials), no such trend is found for the effectiveness of the decomposition catalysts of the invention. Rather, the rare earth oxides of Nd which have a particularly low basicity can be more effective when selecting a suitable support oxide than the more strongly basic oxides of La or Ce (cf. for example, FIG. 4 described in more detail in the examples).

For this reason, the less basic rare earth metal oxides from that of Pr onwards, i.e. Pr, Nd, Sm, Eu, Gd, Tb, Dy, Ho, Er, Tm, Yb, Lu oxides or mixtures of at least two of these oxides, are preferred according to the present invention, with particular preference being given to praseodymium, samarium, europium, gadolinium, terbium, dysprosium, holmium, erbium, thulium or ytterbium oxides or mixed oxides or mixtures of at least two of the abovementioned rare earth oxides as promoters.

As regards the weight ratio of rare earth oxide to support material, any value in the range from 0.1% by weight to 98% by weight is possible in principle, with preference being given to a proportion of rare earth oxides, relative to the total amount of support materials, in the range from 2% by weight to 30% by weight.

In a preferred embodiment, at least 30% by weight of the total rare earth oxides present in the catalyst are in contact with the active metal(s), with the contact being able to be established via a shared interface between rare earth oxide and active metal or via a third interface common to the rare earth oxide and the active metal or by means of both.

In a particularly preferred embodiment, the rare earth oxide is doped with at least one further oxide selected from the group consisting of zirconium oxide, titanium oxide and hafnium oxide.

Apart from the above-described necessary components of the catalyst of the invention, all conceivable auxiliaries and/or additives can be used in producing the catalyst or for its subsequent treatment, e.g. mixed oxides of Ce/Zr as additives to the support material, binders, fillers, hydrocarbon adsorbers or other adsorbent materials, dopants for increasing the thermal stability and mixtures of at least two of the abovementioned substances.

The effectiveness of the catalysts depends particularly on the macroscopic configuration and the morphology of the catalyst. For the configuration of the catalyst, all embodiments which have been found to be useful quite generally in catalyst research are preferred, i.e. in particular “washcoat” and/or “honeycomb” technologies.

The last-named technologies are based on the predominant proportion of the support material being milled in aqueous suspension to particle sizes of a few microns and then being applied to a shaped ceramic or metallic body. In principle, further components in water-soluble or insoluble form can be introduced into the washcoat before or after the coating operation.

After all constituents of the catalyst have been applied to the shaped body, the latter is generally dried and calcined at elevated temperatures.

Particular preference is given to forms of the support material which have a high BET surface area. As regards the pore structure, particular preference is given to macropores which are connected to form channels and coexist with mesopores and/or micropores. The mesopores and/or the micropores contain the actual catalytically active material, here the active metal together with the promoter. Furthermore, it is preferred according to the present invention that (i) active metal and promoter are present together in direct topographical proximity and that (ii) active metal and promoter as a unit are distributed as homogeneously as possible in the porous support material. In principle, there are three conceivable configurations of the relative arrangement of Rh relative to the optional further active metal(s): (i) there are at least two types of support particles, for example aluminium oxide and zirconium oxide, and both Rh and the further active metal(s) are deposited on at least one of the at least two types of support particle but not on at least one other of the at least two support particles, (ii) Rh and the further active metal(s) are deposited together on at least one of the at least two different support materials while either Rh or the further active metal(s) is present on the other(s) of the at least two support particles, and (iii) Rh and the further active metal(s) are each applied to different support particles.

For many applications, it will be useful to immobilise part of the further active metal(s) together with the Rh on a common support oxide and to deposit another part of the further active metal separately from the Rh on another support oxide or the same support oxide, since targeted setting of the NOₓ temperature window of the catalyst is possible in this way.

To achieve homogeneous distribution of the catalytically active substances, i.e. in particular to achieve homogeneous distribution of active metals and rare earth oxides, it is in principle possible to use any process which is known to those skilled in the art for producing catalysts, in particular impregnated and coated catalysts. Examples which may be mentioned are: impregnation of the support materials with metal salt solutions, adsorption of metal salts from gases or liquids on the support materials, application by precipitation from solutions, formation of layers and/or double layers, introduction of colloids, gels, nanosize particles, spraying on or precipitation from solutions.

The method according to the invention of reacting/detoxifying the exhaust gases from a lean-burn engine according to the principle of an above-defined three-way catalyst comprises operating the above-described catalyst of the invention in a rich-lean cycle. The time windows of this rich-lean cycle are selected so that the nitrogen oxides are decomposed over the reduced active metal of the catalyst during the lean phase and the active metal remains in a (partially) reduced state even under lean conditions, i.e. in the presence of an excess of oxygen, due to it being intimately mixed with a promoter.

This time window is given by two parameters, namely the duration of the lean phase and the ratio of lean phase to rich phase. In general, any choice of parameters which leads to a satisfactory integrated nitrogen oxide conversion is included. The duration of the lean phase depends largely on the concentration of oxygen and of nitrogen oxides in the exhaust gas and also on the total volume flow of exhaust gases and the temperature at the catalyst. The duration of the rich phase is determined by the factors air index λ, the concentrations of H₂ and CO in the exhaust gas and the total volume flow. The ratio of lean phase to rich phase is preferably greater than 5:1, more preferably greater than 10:1 and particularly preferably greater than 15:1. The duration of the lean phase can be any desired time, but for practical applications in normal operation a time window of from 5 to 240 seconds, in each case inclusive, is preferred and a time window of from 10 to 120 seconds is particularly preferred.

In this context, it should be noted that the method of the invention, like any method of catalysing exhaust gases in a regulated manner, is regulated or can be regulated not only by sensors and control codes but is also influenced by the way the engine is run. Thus, for example, “natural” enrichment occurs when the engine is accelerated to high speeds and/or abruptly or is operated under high loads. In such operation states, operation can, for example, temporarily be switched to non-lean operation at λ=1 or λ<1, or it is possible for the rich phase to continue for a longer period than is usual in normal, regulated operation, or that the rich phase is favoured as a result of the operating conditions.

In a preferred embodiment, an NOₓ sensor is used for controlling the rich-lean cycle and a relatively rich phase in induced precisely when a predetermined NOₓ limit value is reached.

As regards the use of the catalyst of the invention, its installation in a position close to the engine or installation in a position under the floor is preferred. The catalyst of the invention can also be operated in combination with at least one further catalyst or filter selected from the following group: conventional light-off catalysts, HC-DeNOₓ catalysts, NOₓ storage catalysts, soot or particle filters. It is possible for, for example, the soot particle filter to be coated with the catalyst of the invention. The catalyst of the invention can be combined with the abovementioned catalysts by (i) sequential arrangement of the various catalysts, (ii) physical mixing of the various catalysts and application to a common shaped body or (iii) application of the various catalysts in the form of layers to a common shaped body, and naturally by any combination thereof.

A preferred mode of operation is also defined by the rich-lean operation being regulated by means of an NOₓ sensor which is preferably located downstream of the last exhaust gas catalyst, with a rich phase being induced when a prescribed NOₓ threshold value is exceeded.

The following examples illustrate the production of examples of catalysts according to the invention and demonstrate their improved properties compared with the prior art. The fact that this occurs in specific examples with specific numerical values being reported should not be regarded as any restriction of the scope of the invention as defined in the description and the claims.

### BRIEF DESCRIPTION OF THE FIGURES

In the following, a brief description of the Figures is given:

FIG. 1: shows the NOₓ-conversion of storage catalysts according to the prior art.

FIG. 2: shows the NOₓ-conversion of the catalysts of example 1, however, with the effect of poisoning/aging taken into account.

FIG. 3: shows the NOₓ-conversion of catalysts according to the invention (Rh/Pt doped with rare earth oxide promoters.)

FIG. 4: shows the NOₓ-conversion of the same catalysts as in FIG. 4, however, with the effect of poisoning/aging taken into account.

FIG. 5: shows the CO oxidation capabilities of the catalysts according to the invention.

FIG. 6: shows the HC oxidation capabilities of the catalysts according to the invention.

FIG. 7: shows the increased activity of the catalysts according to the invention with an increasing Rh content.

FIG. 8: shows the effect of rare earth doping on the NOₓ-conversion of the catalysts according to the invention.

FIG. 9: shows the effect, or rather the lack thereof, of the basicity of the rare earth oxides used on the activity of the catalysts according to the invention.

FIG. 10: shows (i) the effect of adding Pt to Rh and (ii) the effect of adding Ti, Zr or Hf oxides to the rare earth oxides, on the NOₓ-conversion for catalysts according to the invention.

### EXAMPLE 1

Production of a Pt-Ba NOₓ Storage Catalyst by Impregnation

For comparative purposes, an NOₓ storage catalyst corresponding to the prior art is produced.

0.36 g of γ-Al₂O₃ miniliths (small monolithic shaped bodies) from Condea are impregnated with 240 μl of a 0.49 molar barium acetate solution. The γ-Al₂O₃ miniliths which have been impregnated in this way are dried at 80° C. for 2 hours. They are subsequently impregnated further with 240 μl of a 0.365 molar cerium nitrate solution. The material is dried once again at 80° C. for 2 hours. They are further impregnated with 240 μl of a 0.078 molar platinum nitrate solution. The miniliths are once again dried at 80° C. for 2 hours and subsequently calcined at 500° C. in air for 4 hours.

### EXAMPLE 2

Production of an Rh NOₓ Decomposition Catalyst Without Promoter by Impregnation

For comparative purposes, an Rh-based NOₓ decomposition catalyst without promoter (corresponding to the prior art) is also synthesised.

100 ml of a 0.0189 molar rhodium nitrate solution are added to 10 g of extruded β-zeolite from Uetikon. This solution is heated to 40° C. and stirred until the supernatant solution is decolourised, i.e. the rhodium has mostly been taken up by the extrudate. The extrudate is filtered off, dried at 80° C. and calcined at 500° C. in air in a muffle furnace for 2 hours.

### EXAMPLE 3

Production of a Pt/Rh Catalyst Doped With Rare Earth According to the Invention by Impregnation

The catalyst is produced as follows by sequential impregnation with aqueous precursor solutions and subsequent calcination: 0.36 γ-Al₂O₃ miniliths from Condea are impregnated with 240 μl of a 0.83 molar gadolinium nitrate solution. The γ-Al₂O₃ which has been impregnated in this way is dried at 80° C. in a drying oven for 2 hours. The miniliths are impregnated with 240 μl of a 0.127 molar rhodium nitrate solution and dried at 80° C. The miniliths are subsequently impregnated with 240 μl of a 0.0078 molar platinum nitrate solution, dried at 80° C. in a drying oven for 2 hours and calcined at 500° C. in air in a muffle furnace for 4 hours.

### EXAMPLE 4

Production of a Pt/Rh Catalyst Doped With Rare Earth According to the Invention by Precipitation

This catalyst is produced by precipitation of the neodymium oxide and subsequent impregnation with the noble metal salts:

0.36 g of γ-Al₂O₃ miniliths from Condea are impregnated with 240 μl of a 0.71 molar gadolinium nitrate solution. The gadolinium is precipitated onto the γ-Al₂O₃ by addition of 100 μl of a 20% strength NH₃ solution. The miniliths are dried at 80° C. in a drying oven for 2 hours. The miniliths are subsequently impregnated with 240 μl of a 0.127 molar rhodium nitrate solution and dried at 80° C. The miniliths are impregnated with 240 μl of a 0.0078 molar platinum nitrate solution, dried at 80° C. in a drying oven for 2 hours and calcined at 500° C. in air in a muffle furnace for 4 hours.

All catalysts produced by the synthetic route described in Examples 1 to 4 and characterized in one of the following examples are shown in the table below. As support oxide (SO), use was made of either γ-Al₂O₃ (empty field) or TiO₂ (t) or ZrO₂ (z) or β-zeolite (b). All weights reported in per cent by weight are based on the mass of the support oxide. Finally, the last column of the table gives the state of the catalyst, i.e. whether it is a freshly produced catalyst (=fresh) or an aged catalyst (=aged), i.e. a catalyst which has been exposed to sulphur impurities.

TABLE 1

| | | | | | | | | | mass of | | |
|---|---|---|---|---|---|---|---|---|---|---|---|
| | | | | | | | | mass | alkaline | | |
| | | | | | | | | of rare | earth | | |
| | | | | | | Rh | Pt | earth | metal | mass | |
| | | rare | alkaline | | mass of | loading | loading | oxide | oxide | IVB | |
| | | earth | earth | IVB | support | [% | [% | [% | [% | oxide | state |
| catalyst ID | SO | oxide | oxide | Oxide | oxide [g] | by wt] | by wt] | by wt] | by wt] | [Gew. %] | of cat. |
| Pt-Ba-1 | | CeO₂ | BaO | — | 0.36 | — | 1.0 | 4.0 | 5.0 | — | fresh |
| Pt-Ba-2 | | CeO₂ | BaO | — | 0.36 | — | 1.0 | 4.0 | 10.0 | — | fresh |
| Pt-Ba-3 | | CeO₂ | BaO | — | 0.36 | — | 2.0 | 4.0 | 5.0 | — | fresh |
| Pt-Ba-4 | | CeO₂ | BaO | — | 0.36 | — | 2.0 | 4.0 | 10.0 | — | fresh |
| Pt-Ba-5 | | CeO₂ | BaO | — | 0.36 | — | 0.8 | 4.0 | 7.5 | — | fresh |
| Pt-Ba-6 | | CeO₂ | BaO | — | 0.36 | — | 2.2 | 4.0 | 7.5 | — | fresh |
| Pt-Ba-7 | | CeO₂ | BaO | — | 0.36 | — | 1.5 | 4.0 | 3.8 | — | fresh |
| Pt-Ba-8 | | CeO₂ | BaO | — | 0.36 | — | 1.5 | 4.0 | 12.0 | — | fresh |
| Pt-Ba-9 | | CeO₂ | BaO | — | 0.36 | — | 1.5 | 4.0 | 7.5 | — | fresh |
| Pt-Ba-10 | | CeO₂ | BaO | — | 0.36 | — | 0.2 | 4.0 | 8.0 | — | fresh |
| Pt-Ba-11 | | CeO₂ | BaO | — | 0.36 | — | 0.2 | 4.0 | 3.0 | — | fresh |
| Pt-Ba-12 | | CeO₂ | BaO | — | 0.36 | — | 1.1 | 4.0 | 12.0 | — | fresh |
| Pt-Ba-13 | | CeO₂ | BaO | — | 0.36 | — | 1.1 | 4.0 | 3.0 | — | fresh |
| Pt-Ba-14 | | CeO₂ | BaO | — | 0.36 | — | 0.8 | 4.0 | 0.0 | — | fresh |
| Pt-Ba-15 | | CeO₂ | BaO | — | 0.36 | — | 2.2 | 4.0 | 0.0 | — | fresh |
| Pt-Ba-1-a | | CeO₂ | BaO | — | 0.36 | — | 1.0 | 4.0 | 5.0 | — | aged |
| Pt-Ba-2-a | | CeO₂ | BaO | — | 0.36 | — | 1.0 | 4.0 | 10.0 | — | aged |
| Pt-Ba-3-a | | CeO₂ | BaO | — | 0.36 | — | 2.0 | 4.0 | 5.0 | — | aged |
| Pt-Ba-4-a | | CeO₂ | BaO | — | 0.36 | — | 2.0 | 4.0 | 10.0 | — | aged |
| Pt-Ba-5-a | | CeO₂ | BaO | — | 0.36 | — | 0.8 | 4.0 | 7.5 | — | aged |
| Pt-Ba-6-a | | CeO₂ | BaO | — | 0.36 | — | 2.2 | 4.0 | 7.5 | — | aged |
| Pt-Ba-7-a | | CeO₂ | BaO | — | 0.36 | — | 1.5 | 4.0 | 3.8 | — | aged |
| Pt-Ba-8-a | | CeO₂ | BaO | — | 0.36 | — | 1.5 | 4.0 | 12.0 | — | aged |
| Pt-Ba-9-a | | CeO₂ | BaO | — | 0.36 | — | 1.5 | 4.0 | 7.5 | — | aged |
| Pt-Ba-10-a | | CeO₂ | BaO | — | 0.36 | — | 0.2 | 4.0 | 8.0 | — | aged |
| Pt-Ba-11-a | | CeO₂ | BaO | — | 0.36 | — | 0.2 | 4.0 | 3.0 | — | aged |
| Pt-Ba-12-a | | CeO₂ | BaO | — | 0.36 | — | 1.1 | 4.0 | 12.0 | — | aged |
| Pt-Ba-13-a | | CeO₂ | BaO | — | 0.36 | — | 1.1 | 4.0 | 3.0 | — | aged |
| Pt-Ba-14-a | | CeO₂ | BaO | — | 0.36 | — | 0.8 | 4.0 | 0.0 | — | aged |
| Pt-Ba-15-a | | CeO₂ | BaO | — | 0.36 | — | 2.2 | 4.0 | 0.0 | — | aged |
| Gd-Pt-Rh-1 | | Gd₂O₃ | — | — | 0.36 | 1.0 | 0.0 | 10.0 | — | — | fresh |
| Gd-Pt-Rh-2 | | Gd₂O₃ | — | — | 0.36 | 0.9 | 0.1 | 10.0 | — | — | fresh |
| Gd-Pt-Rh-3 | | Gd₂O₃ | — | — | 0.36 | 0.8 | 0.2 | 10.0 | — | — | fresh |
| Gd-Pt-Rh-4 | | Gd₂O₃ | — | — | 0.36 | 0.5 | 0.5 | 10.0 | — | — | fresh |
| Gd-Pt-Rh-5 | | Gd₂O₃ | — | — | 0.36 | 0.3 | 0.7 | 10.0 | — | — | fresh |
| Gd-Pt-Rh-6 | | Gd₂O₃ | — | — | 0.36 | 0.2 | 0.8 | 10.0 | — | — | fresh |
| Gd-Pt-Rh-7 | | Gd₂O₃ | — | — | 0.36 | 0.0 | 1.0 | 10.0 | — | — | fresh |
| Nd-Pt-Rh-1 | | Nd₂O₃ | — | — | 0.36 | 1.0 | 0.0 | 10.0 | — | — | fresh |
| Nd-Pt-Rh-2 | | Nd₂O₃ | — | — | 0.36 | 0.9 | 0.1 | 10.0 | — | — | fresh |
| Nd-Pt-Rh-3 | | Nd₂O₃ | — | — | 0.36 | 0.8 | 0.2 | 10.0 | — | — | fresh |
| Nd-Pt-Rh-4 | | Nd₂O₃ | — | — | 0.36 | 0.5 | 0.5 | 10.0 | — | — | fresh |
| Nd-Pt-Rh-5 | | Nd₂O₃ | — | — | 0.36 | 0.3 | 0.7 | 10.0 | — | — | fresh |
| Nd-Pt-Rh-6 | | Nd₂O₃ | — | — | 0.36 | 0.2 | 0.8 | 10.0 | — | — | fresh |
| Nd-Pt-Rh-7 | | Nd₂O₃ | — | — | 0.36 | 0.0 | 1.0 | 10.0 | — | — | fresh |
| Pr-Pt-Rh-1 | | Pr₆O₁₁ | — | — | 0.36 | 1.0 | 0.0 | 10.0 | — | — | fresh |
| Pr-Pt-Rh-2 | | Pr₆O₁₁ | — | — | 0.36 | 0.9 | 0.1 | 10.0 | — | — | fresh |
| Pr-Pt-Rh-3 | | Pr₆O₁₁ | — | — | 0.36 | 0.8 | 0.2 | 10.0 | — | — | fresh |
| Pr-Pt-Rh-4 | | Pr₆O₁₁ | — | — | 0.36 | 0.5 | 0.5 | 10.0 | — | — | fresh |
| Pr-Pt-Rh-5 | | Pr₆O₁₁ | — | — | 0.36 | 0.3 | 0.7 | 10.0 | — | — | fresh |
| Sm-Pt-Rh-1 | | Sm₂O₃ | — | — | 0.36 | 1.0 | 0.0 | 10.0 | — | — | fresh |
| Sm-Pt-Rh-2 | | Sm₂O₃ | — | — | 0.36 | 0.9 | 0.1 | 10.0 | — | — | fresh |
| Sm-Pt-Rh-3 | | Sm₂O₃ | — | — | 0.36 | 0.8 | 0.2 | 10.0 | — | — | fresh |
| Sm-Pt-Rh-4 | | Sm₂O₃ | — | — | 0.36 | 0.5 | 0.5 | 10.0 | — | — | fresh |
| Sm-Pt-Rh-5 | | Sm₂O₃ | — | — | 0.36 | 0.3 | 0.7 | 10.0 | — | — | fresh |
| Sm-Pt-Rh-6 | | Sm₂O₃ | — | — | 0.36 | 0.2 | 0.8 | 10.0 | — | — | fresh |
| Sm-Pt-Rh-7 | | Sm₂O₃ | — | — | 0.36 | 0.0 | 1.0 | 10.0 | — | — | fresh |
| Gd-Pt-Rh-P-1 | | Gd₂O₃ | — | — | 0.36 | 1.0 | 0.0 | 8.0 | — | — | fresh |
| Gd-Pt-Rh-P-2 | | Gd₂O₃ | — | — | 0.36 | 0.9 | 0.1 | 8.0 | — | — | fresh |
| Gd-Pt-Rh-P-3 | | Gd₂O₃ | — | — | 0.36 | 0.8 | 0.2 | 8.0 | — | — | fresh |
| Nd-Pt-Rh-P-1 | | Nd₂O₃ | — | — | 0.36 | 1.0 | 0.0 | 8.0 | — | — | fresh |
| Nd-Pt-Rh-P-2 | | Nd₂O₃ | — | — | 0.36 | 0.9 | 0.1 | 8.0 | — | — | fresh |
| Nd-Pt-Rh-P-3 | | Nd₂O₃ | — | — | 0.36 | 0.8 | 0.2 | 8.0 | — | — | fresh |
| Sm-Pt-Rh-P-1 | | Sm₂O₃ | — | — | 0.36 | 1.0 | 0.0 | 8.0 | — | — | fresh |
| Sm-Pt-Rh-P-2 | | Sm₂O₃ | — | — | 0.36 | 0.9 | 0.1 | 8.0 | — | — | fresh |
| Sm-Pt-Rh-P-3 | | Sm₂O₃ | — | — | 0.36 | 0.8 | 0.2 | 8.0 | — | — | fresh |
| Gd-Pt-Rh-P-1-a | | Gd₂O₃ | — | — | 0.36 | 1.0 | 0.0 | 8.0 | — | — | aged |
| Gd-Pt-Rh-P-2-a | | Gd₂O₃ | — | — | 0.36 | 0.9 | 0.1 | 8.0 | — | — | aged |
| Gd-Pt-Rh-P-3-a | | Gd₂O₃ | — | — | 0.36 | 0.8 | 0.2 | 8.0 | — | — | aged |
| Nd-Pt-Rh-P-1-a | | Nd₂O₃ | — | — | 0.36 | 1.0 | 0.0 | 8.0 | — | — | aged |
| Nd-Pt-Rh-P-2-a | | Nd₂O₃ | — | — | 0.36 | 0.9 | 0.1 | 8.0 | — | — | aged |
| Nd-Pt-Rh-P-3-a | | Nd₂O₃ | — | — | 0.36 | 0.8 | 0.2 | 8.0 | — | — | aged |
| Sm-Pt-Rh-P-1-a | | Sm₂O₃ | — | — | 0.36 | 1.0 | 0.0 | 8.0 | — | — | aged |
| Sm-Pt-Rh-P-2-a | | Sm₂O₃ | — | — | 0.36 | 0.9 | 0.1 | 8.0 | — | — | aged |
| Sm-Pt-Rh-P-3-a | | Sm₂O₃ | — | — | 0.36 | 0.8 | 0.2 | 8.0 | — | — | aged |
| Rh-La-Ti | t | La₂O₃ | — | — | 0.3 | 1.0 | — | 8.0 | — | — | fresh |
| Rh-Pr-Ti | t | Pr₆O₁₁ | — | — | 0.3 | 1.0 | — | 8.0 | — | — | fresh |
| Rh-Gd-Ti | t | Gd₂O₃ | — | — | 0.3 | 1.0 | — | 8.0 | — | — | fresh |
| Rh-Sm-Ti | t | Sm₂O₃ | — | — | 0.3 | 1.0 | — | 8.0 | — | — | fresh |
| Rh-Tb-Ti | t | Tb₂O₃ | — | — | 0.3 | 1.0 | — | 8.0 | — | — | fresh |
| Rh-Yb-Ti | t | Yb₂O₃ | — | — | 0.3 | 1.0 | — | 8.0 | — | — | fresh |
| Rh-Nd-Ti | t | Nd₂O₃ | — | — | 0.3 | 1.0 | — | 8.0 | — | — | fresh |
| Rh-Dy-Zr | z | Dy₂O₃ | | — | 0.3 | 1.0 | — | 8.0 | — | — | fresh |
| Rh-Er-Zr | z | Er₂O₃ | | — | 0.3 | 1.0 | — | 8.0 | — | — | fresh |
| Rh-Lu-Zr | z | Lu₂O₃ | | — | 0.3 | 1.0 | — | 8.0 | — | — | fresh |
| Rh-Eu-Zr | z | Eu₂O₃ | | — | 0.3 | 1.0 | — | 8.0 | — | — | fresh |
| Rh-La-Zr | z | La₂O₃ | — | — | 0.3 | 1.0 | — | 8.0 | — | — | fresh |
| Rh-Pr-Zr | z | Pr₆O₁₁ | — | — | 0.3 | 1.0 | — | 8.0 | — | — | fresh |
| Rh-Gd-Zr | z | Gd₂O₃ | — | — | 0.3 | 1.0 | — | 8.0 | — | — | fresh |
| Rh-Sm-Zr | z | Sm₂O₃ | — | — | 0.3 | 1.0 | — | 8.0 | — | — | fresh |
| Rh-Tb-Zr | z | Tb₄O₇ | — | — | 0.3 | 1.0 | — | 8.0 | — | — | fresh |
| Rh-Yb-Zr | z | Yb₂O₃ | — | — | 0.3 | 1.0 | — | 8.0 | — | — | fresh |
| Rh-Nd-Zr | z | Nd₂O₃ | — | — | 0.3 | 1.0 | — | 8.0 | — | — | fresh |
| Beta-Rh-1 | b | — | — | — | 0.3 | 0.33 | — | — | — | — | fresh |
| Beta-Rh-2 | b | — | — | — | 0.3 | 0.66 | — | — | — | — | fresh |
| Beta-Rh-3 | b | — | — | — | 0.3 | 1 | — | — | — | — | fresh |
| Beta-Rh-4 | b | — | — | — | 0.3 | 1.33 | — | — | — | — | fresh |
| Beta-Rh-5 | b | — | — | — | 0.3 | 1.66 | — | — | — | — | fresh |
| Beta-Rh-6 | b | — | — | — | 0.3 | 2 | — | — | — | — | fresh |
| Beta-Rh-7 | b | — | — | — | 0.3 | 2.33 | — | — | — | — | fresh |
| Beta-Rh-8 | b | — | — | — | 0.3 | 2.66 | — | — | — | — | fresh |
| Beta-Rh-9 | b | — | — | — | 0.3 | 3 | — | — | — | — | fresh |
| Pt-110-Rh000 | | — | — | — | 0.3 | — | 1.1 | — | — | — | fresh |
| Pt-095-Rh-015 | | — | — | — | 0.3 | 0.2 | 1.0 | — | — | — | fresh |
| Pt-090-Rh-020 | | — | — | — | 0.3 | 0.2 | 0.9 | — | — | — | fresh |
| Pt-030-Rh-080 | | — | — | — | 0.3 | 0.8 | 0.3 | — | — | — | fresh |
| Pt-016-Rh-094 | | — | — | — | 0.3 | 0.9 | 0.2 | — | — | — | fresh |
| Pt-000-Rh-110 | | — | — | — | 0.3 | 1.1 | 0.0 | — | — | — | fresh |
| Pt0-Rh1-Pr12 | | Pr₆O₁₁ | — | — | 0.36 | 1.0 | 0.0 | 12 | — | — | fresh |
| Pt0-Rh1-Pr6 | | Pr₆O₁₁ | — | — | 0.36 | 1.0 | 0.0 | 6 | — | — | fresh |
| Pt0.1-Rh0.9-Pr12 | | Pr₆O₁₁ | — | — | 0.36 | 0.9 | 0.1 | 12 | — | — | fresh |
| Pt0.9-Rh0.1-Pr12 | | Pr₆O₁₁ | — | — | 0.36 | 0.1 | 0.9 | 12 | — | — | fresh |
| Pt0-Rh1-Pr11.5-Zr0.5 | | Pr₆O₁₁ | — | ZrO₂ | 0.36 | 1.0 | 0.0 | 11.5 | — | 0.5 | fresh |

### EXAMPLE 5

Performance Tests, in Particular to Determine the NOₓ Conversion, on the Catalysts of the Invention Compared with Catalysts According to the Prior Art:

The test and ageing conditions to which the above-described catalysts were subjected are shown in the table below. Each catalyst was exposed to a gas mixture in a closed, temperature-regulated reaction chamber. The gas mixture was mixed from the starting gases (see table) in a mixing chamber so that realistic exhaust gas conditions in rich and/or lean operation were simulated. In lean operation, corresponding to realistic exhaust gas conditions, the catalyst was exposed to a mixture of carbon monoxide, hydrocarbon, water, nitrogen and NO plus 6% of oxygen, i.e. the air index is greater than 1.2, while in rich operation the oxygen content is reduced to zero.

The ageing process is simulated by addition of vppm quantities (ppm by volume) of sulphur dioxide, as also corresponds to realistic conditions in fuel combustion.

TABLE 2

| Test conditions: | | Ageing: | |
|---|---|---|---|
| CO (lean): | 800 vppm | O₂: | 6.0 vol. % |
| C₃H₆: | 150 vppm | H₂O: | 8.0 vol. % |
| NO: | 380 vppm | SO₂: | 100 vppm |
| O₂ (lean): | 6.0 vol. % | N₂: | balance |
| O₂ (rich): | 0.0 vol. % | | |
| CO (rich): | 5.0 vol. % | Total flow | 30 standard l/h |
| H₂ (rich) | 1.67 vol. % | T: | 400° C. |
| H₂O | 8.0 vol. % | Ageing time: | 48 hours |
| N₂ | balance | | |
| Total flow | 60 standard l/h | | |
| t(lean) | 80 seconds | | |
| t(rich) | 2.5 seconds | | |
| T: | variable | | |

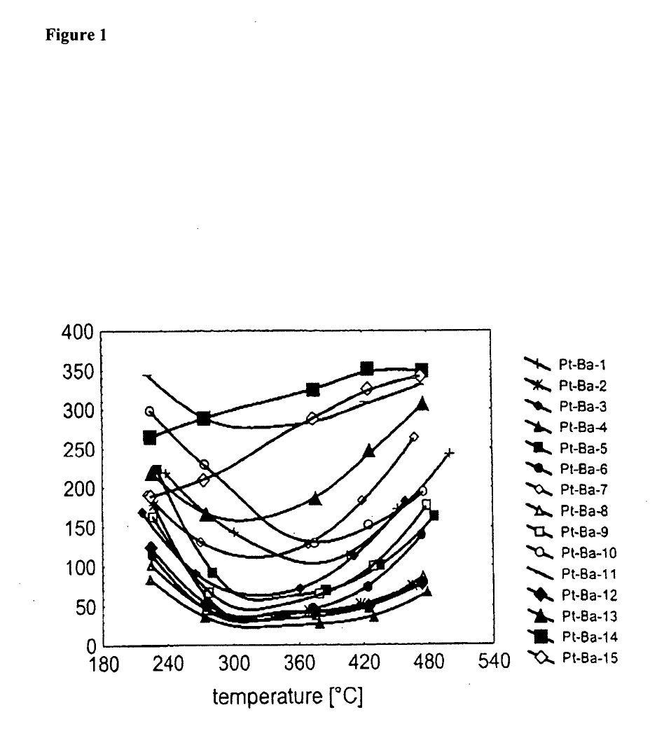

Under test conditions, the respective catalyst was, in a series of cycles, exposed to rich conditions for the time windows indicated in the table and otherwise operated under lean conditions. Subsequent to the rich phase, i.e. in once again lean operation, the nitrogen oxide content occurring downstream of the catalyst was then measured and integrated for 45 seconds each time. The measurements of the NOₓ concentration were carried out in a time-resolved manner at a data capture rate of 0.5 Hz. To determine the NOₓ decomposition efficiency, a mean of the NOₓ concentration is then calculated over 45 seconds immediately after occurrence of the 2.5 second rich phase. This can then be compared with the originally introduced 380 vppm. This measurement is repeated for various “exhaust gas” temperatures and the temperature in degrees celsius is indicated on the horizontal axis, i.e. the x axis, in FIGS. 1 to 10.

In FIGS. 1 to 4 and 7 to 10, the y vertical axis in each case shows the NOₓ content in vppm (volume parts per million) measured downstream of the respective catalyst as described in the last section.

FIG. 1 shows the conversion achieved by fresh, i.e. not contaminated with sulphur, storage catalysts according to the prior art (cf. the corresponding catalyst IDs in Table 1 above). The best of these catalysts (e.g. Pt-Ba-4 with BaO as alkaline earth storage oxide), which are in the activated state, efficiently convert nitrogen oxides down to 20 vppm at virtually all temperatures.

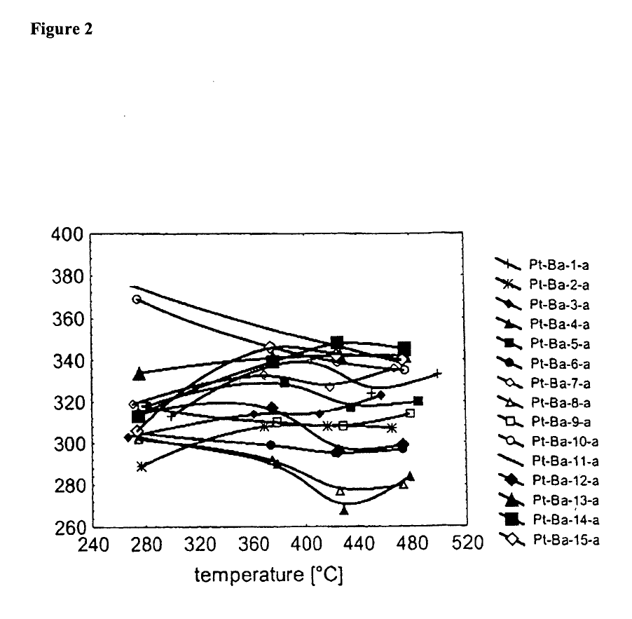

In FIG. 2, the same measurement has been repeated using the same catalysts, with the effect of poisoning by sulphur/effect of ageing now also being taken into account (conditions: cf. Table 2). Even the best storage catalysts now display a reduction in nitrogen oxide concentration to only about 280 vppm. Once again, this applies to the same extent at virtually all temperatures.

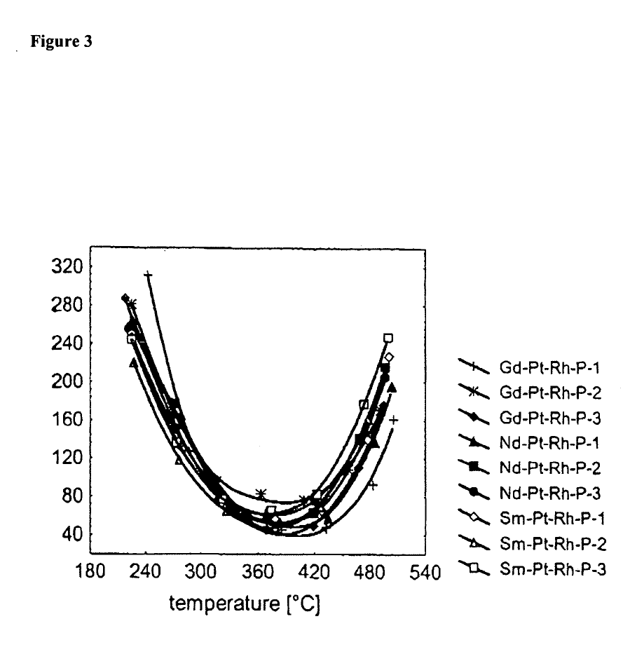

FIG. 3 shows the conversion of nitrogen oxides using the unaged catalyst according to the invention (Rh/Pt doped with Gd, Nd or Sm as rare earth oxide promoter). The storage catalyst according to the prior art (comparison with FIG. 1) in the fresh state is superior in terms of the NOₓ conversion to the decompsoition catalyst of the invention at low temperatures (below 300° C.) and at high temperatures (above 420° C.) and is slightly superior or similarly good at temperatures in the range from 300° C. to 420° C.

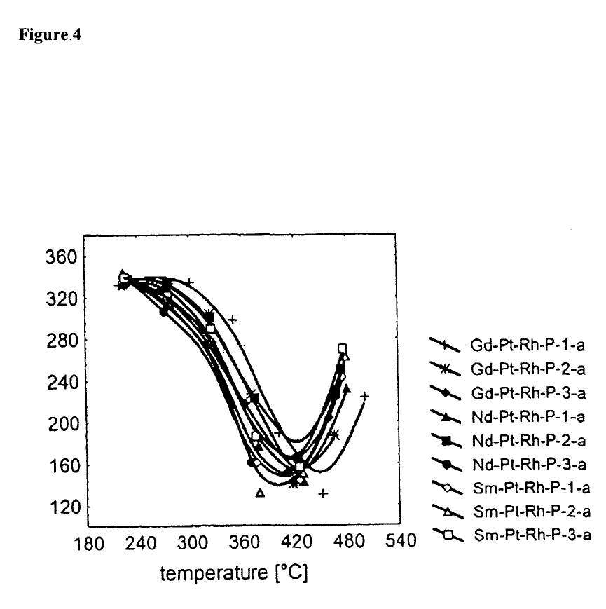

However, this picture changes when, as is shown in FIG. 4, the catalyst according to the invention is aged in the presence of sulphur under the same conditions as the storage catalyst according to the prior art for FIG. 2 (cf. Table 2 above). While the storage catalyst in the aged state at best converts nitrogen oxide from 380 vppm to 280 vppm (see FIG. 2), the decompsoition catalyst of the invention is able to convert nitrogen oxides down to 120 vppm, in particular at temperatures which correspond to typical exhaust gas temperatures of lean-burn engines. This corresponds to an improvement by more than a factor of 2 compared with the prior art.

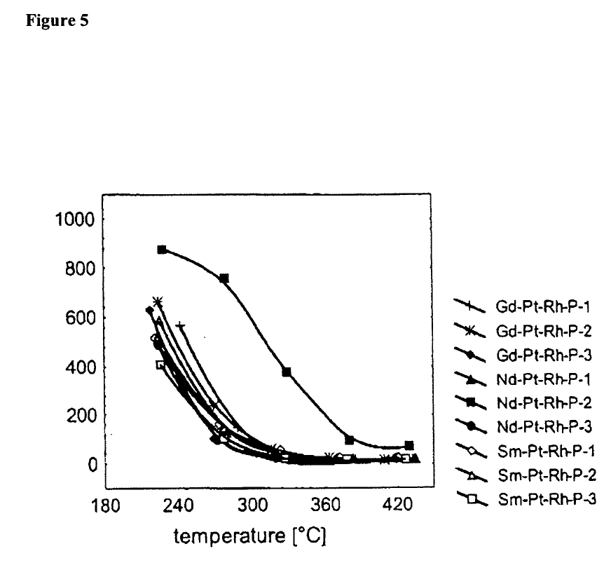

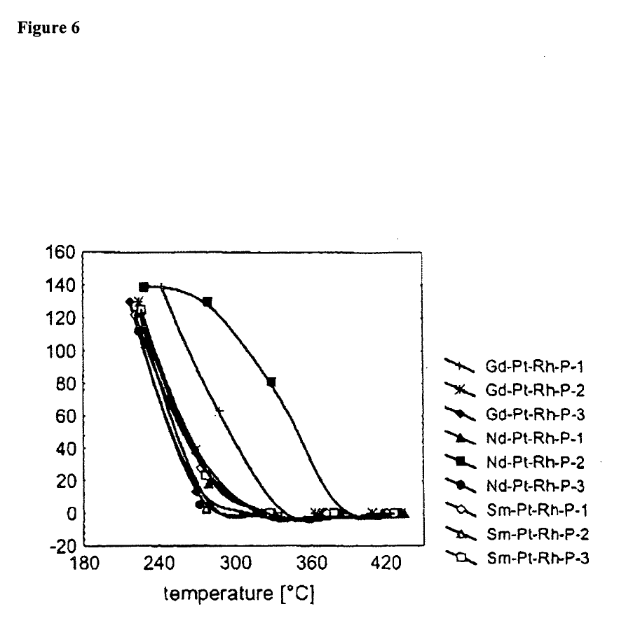

The fact that the catalyst of the invention actually functions in three-way operation, i.e. also oxidises hydrocarbons (HC) and carbon monoxide, is in each case shown in FIG. 5 (CO oxidation, vertical y axis: vppm content of CO downstream of the catalyst) and FIG. 6 (HC oxidation, vertical y axis: vppm content of HC). Thus, for example, the catalysts of the invention containing Sm as promoter (e.g. Sm-Pt-Rh-P-3) remove virtually all carbon monoxide and virtually all hydrocarbons at realistic exhaust gas temperatures of about 300° C.

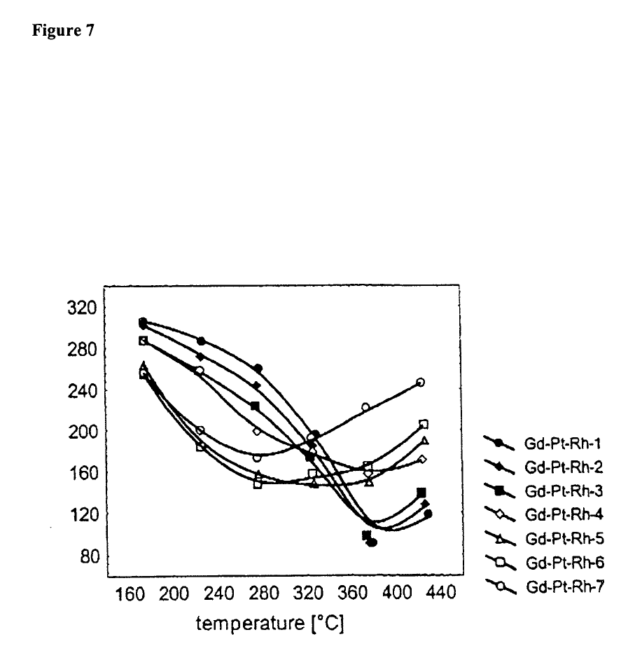

FIG. 7 demonstrates the above-discussed, increased activity of catalysts according to the invention having an increased Rh content compared with otherwise identical catalysts according to the invention having an increased Pt content. It can be seen that Pt-containing catalysts which come close to the storage catalysts according to the prior art convert more NOₓ at relatively low temperatures (up to about 280° C.), presumably since the superior NO₂ formation and storage on the Pt has a major effect here, while at higher temperatures at which Rh and Pt form NO₂ to the same extent, the superior NOₓ decomposition capacity of Rh dominates. This can be seen, in particular, by comparison of Gd-Pt-Rh-4 (0.8% by weight of Rh and 0.2% by weight of Pt) with Gd-Pt-Rh-7 (no Rh, 1% by weight of Pt), in which case the Rh-rich catalyst is about twice as active as the pure Pt catalyst at exhaust gas temperatures which are relevant for a lean-burn engine.

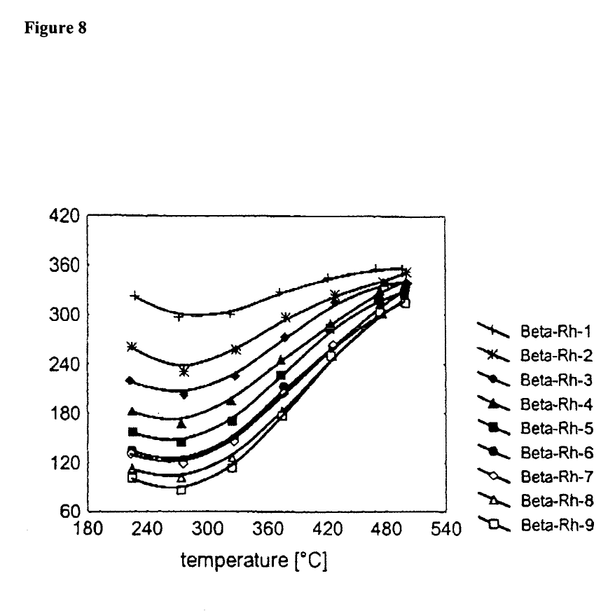

FIG. 8 shows that an Rh-containing decompsoition catalyst without doping with rare earth oxides according to the prior art is clearly inferior to the Rh-containing decomposition catalyst of the invention with rare earth oxide doping (cf. FIG. 3), in particular at the relatively high temperutres relevant for lean-burn engines.

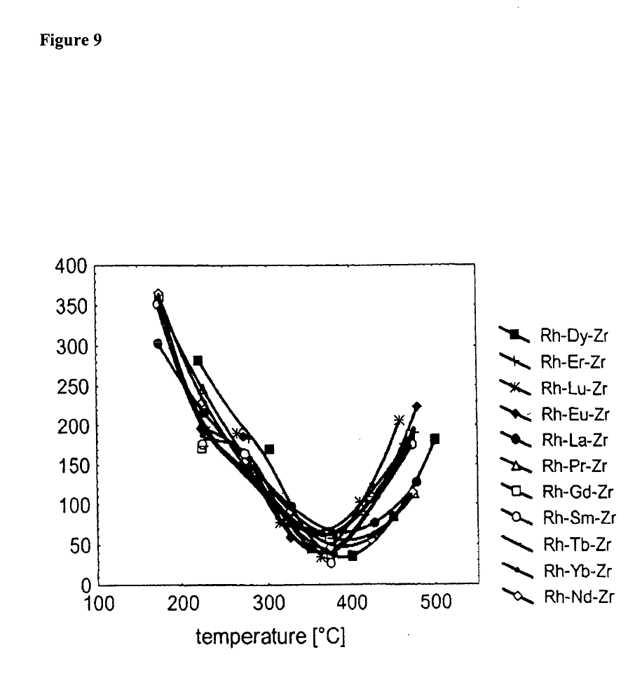

FIG. 9 shows that in the case of the catalysts of the invention and in contrast to the storage catalysts according to the prior art, the basicity of the oxides used (storage catalysts: alkaline earth metal oxides; decomposition catalysts according to the invention: rare earth oxides) has no significant influence on the activity of the catalyst, especially not in a systematic way. In complete contrast to the behaviour found in the case of storage catalysts, a reduced basicity sometimes even results in an improved activity.

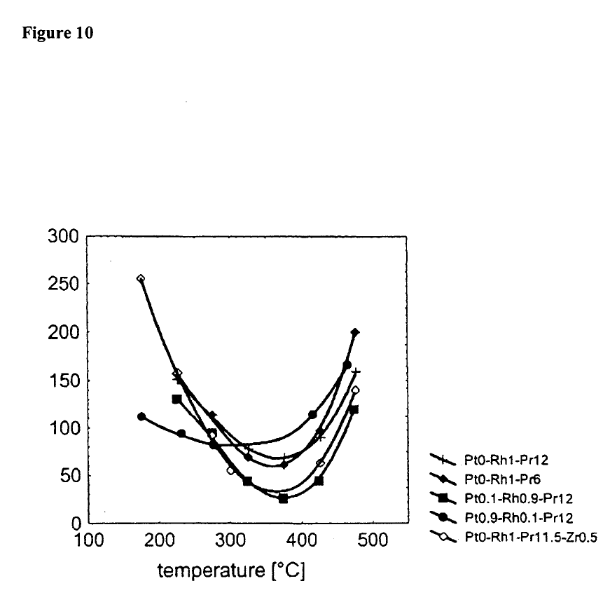

Finally, FIG. 10 shows two things: (i) firstly, the NOₓ activity of the catalyst of the invention can be increased by doping of the Rh-rich catalyst with small amounts of Pt (cf. Pt0-Rh1-Pr12 versus Pt0.1-Rh0.9-Pr12) and, in particular, the behaviour at relatively low temperatures can also be improved, and secondly (ii) doping of the rare earth oxide with an oxide selected from the group consisting of zirconium, hafnium and titanium oxides can increase the activity of the catalyst of the invention (cf. Pt0-Rh1-Pr12 versus Pt0-Rh1-Pr11.5-Zr0.5), in this example even without any addition of Pt.

1-13. (canceled)

14. A catalyst for purifying exhaust gases from lean-burning engines, comprising:
(i) at least one porous support material;
(ii) rhodium as active metal, either alone or together with at least one further active metal, wherein the mass ratio, based on the elements, of rhodium to the sum of all further active metals in the catalyst is at least 1:4.5; and
(iii) at least one rare earth oxide as promoter.

15. A catalyst according to claim 14, wherein the proportion of the sum of rhodium and all further active metals used relative to the total porous support material used in the catalyst is in the range from 0.1% by weight to 3% by weight.

16. A catalyst according to claim 14, wherein the porous support material is selected from the group consisting of refractory oxides, mixed oxides and oxide mixtures.

17. A catalyst according to claim 14, wherein the further active metal or metals is/are selected from the group consisting of Ru, Pd, Os, Ir, Pt.

18. A catalyst according to claim 14, wherein the rare earth oxide or oxides which function(s) as promoter is/are selected from the group consisting of La, Ce, Pr, Nd, Sm, Eu, Gd, Tb, Dy, Ho, Er, Tm, Yb, Lu oxide and mixtures and/or mixed oxides of at least two of the above-mentioned oxides.

19. A catalyst according to claim 14, wherein the rare earth oxide is doped with at least one further oxide selected from the group consisting of zirconium oxide, titanium oxide and hafnium oxide.

20. A method of purifying exhaust gases from lean-burning engines in rich-lean operation, wherein at least one catalyst according to claim 1 is used.

21. A method according to claim 20, wherein the rich-lean operation is carried out in alternating rich and lean cycles, with the ratio of the duration of lean cycles to rich cycles during normal operation being at least 10:1 and the absolute duration of a lean cycle in normal operation being from 10 seconds to 120 seconds.

22. A method according to claim 20, wherein the purification of exhaust gas comprises the simultaneous oxidation of hydrocarbons and carbon monoxide and the reduction of nitrogen oxides and, optionally in the case of diesel engines, the removal of soot.

23. A method according to claim 20, wherein the lean-bum engine is selected from the group consisting of gasoline engines with direct gasoline injection, hybrid engines, diesel engines, multifuel engines, stratified charge engines and also gasoline engines with unthrottled part-load operation and relatively high compression or with unthrottled part-load operation or relatively high compression, in each case together with direct injection.

24. A method according to claim 20, wherein the catalyst according to claim 1 is used in any combination with at least one catalyst or filter selected from the following group: starting catalyst, HC-SCR catalyst, NOₓ storage catalyst, λ-regulated three-way catalyst, particle filter, and soot filter.

25. A method according to claim 24, wherein the combination of the catalyst of the invention with at least one of the catalysts or filter of claim 24 is in accordance with at least one arrangement selected from the group consisting of: (i) sequential arrangement of the various catalysts, (ii) physical mixing of the various catalysts and application to a common shaped body or (iii) application of the various catalysts in the form of layers to a common shaped body.

26. Use of rare earth oxides for doping catalysts used in the purification of exhaust gases from lean-burn engines.
